(19) United States
(12) Patent Application Publication
(10) Pub. No.: US 2026/0180240 A1
(43) Pub. Date: Jun. 25, 2026

(54) REMOTELY SWITCHABLE POWER PLUG APPARATUS

(71) Applicant: Todd Johnston, Yamba (AU)

(72) Inventor: Todd Johnston, Yamba (AU)

(21) Appl. No.: 19/125,971

(22) PCT Filed: Nov. 6, 2023
(86) PCT No.: PCT/AU2023/051116

§ 371 Date: Apr. 30, 2025

(30) Foreign Application Priority Data
Nov. 7, 2022 (AU) 2022903321

(51) Int. Cl. H01R 13/53

(52) U.S. Cl. CPC H01R 13/53

(57) ABSTRACT

Remotely switchable power plug apparatus has an electrical adapter designed with plug pins for wall socket connection and at least one front-facing outlet socket. It incorporates a switch lead socket and can be remotely controlled using a switch lead. The switch lead includes a plug, a switch, and cabling to facilitate remote power control. A gate within the switch lead socket is deflected to open or close an electrical circuit when the plug is inserted, enabling remote power management, making it especially convenient for hidden installations, such as behind a TV cabinet.

### FIELD OF THE INVENTION

This invention relates to power plug apparatus which is remotely switchable using a remote switch lead.

### BACKGROUND OF THE INVENTION

Power boards with a plurality of outlet sockets are commonly used to provide a convenient and centralized power source for multiple electrical devices in various settings. They are often used in home and office environments to plug in various pieces of electrical equipment, making it easier to manage and power multiple devices simultaneously. For example, in an entertainment setup, audiovisual equipment like televisions, gaming consoles, DVD players, and sound systems can all be electrically connected to a power board concealed behind a TV cabinet. This simplifies cable management and ensures that all devices receive power from a single source.

However, a common issue with these power boards, especially when concealed behind furniture like TV cabinets, is the difficulty in turning off the power to save energy. Since they are not easily accessible, users often leave them powered on, even when the connected devices are not in use. This can result in unnecessary energy consumption and higher electricity bills.

To address this problem, there is a need for remote control solutions. These solutions may include:

As such, a need exists for a remote-control solution whereby users can effectively manage the power consumption of electrical equipment connected to power boards, even when the power boards are concealed behind furniture to not only saves energy but also enhance the ease of use and control over their electronic devices.

It is to be understood that, if any prior art information is referred to herein, such reference does not constitute an admission that the information forms part of the common general knowledge in the art, in Australia or any other country.

### SUMMARY OF THE DISCLOSURE

There is provided herein remotely switchable power plug apparatus which comprises an adapter with plug pins and at least one outlet socket, along with a switch lead socket.

The apparatus allows for remote control using a remote switch lead that can be connected to the adapter.

The remote switch lead includes a plug with plug contacts to connect with the switch lead socket contacts. The switch lead socket features a swing gate with a conductor that, by default, completes a circuit between the plug pins and the outlet socket.

However, when the plug is inserted, it deflects the gate to an open position, disconnecting the conductor and enabling the plug contacts to establish a circuit between the plug pins, outlet socket, and switch, allowing for remote power control.

The apparatus may comprise a safety mechanism involving a concealed latch with a magnetic arm and a permanent magnet in the plug to prevent to prevent insertion of objects into the switch lead socket. When the plug is placed against the gate, the magnet attracts the magnetic arm, releasing the latch and allowing the gate to open.

The apparatus enables the remote control of power, which can be particularly useful when the adapter is installed behind a TV cabinet or similar furniture.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a front perspective view of an adapter of remotely switchable power plug apparatus in accordance with an embodiment;

FIG. 2 shows a rear perspective view of the adapter;

FIG. 3 shows a remote switch lead configured for selective attachment to the adapter;

FIG. 4 shows a cross-sectional view of a switch lead socket of the adapter in a closed position from a first direction;

FIG. 5 shows a cross-sectional view of the switch lead socket in an open position from the first direction;

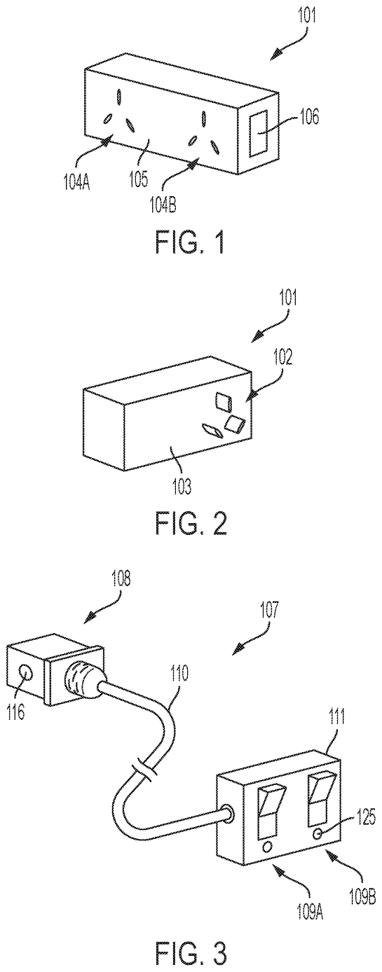

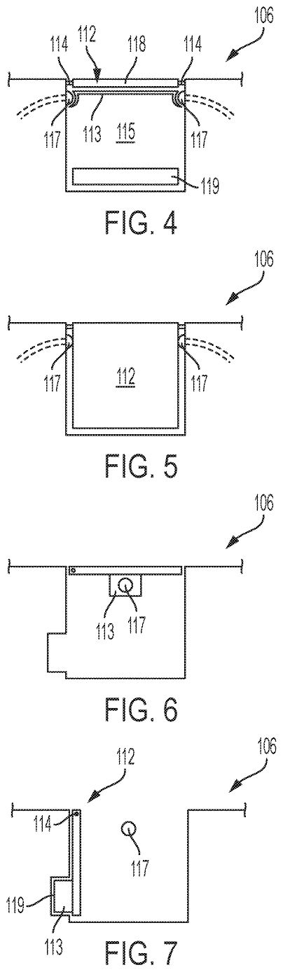

FIG. 4 shows a cross-sectional view of a switch lead socket of the adapter in a closed position from a second direction;

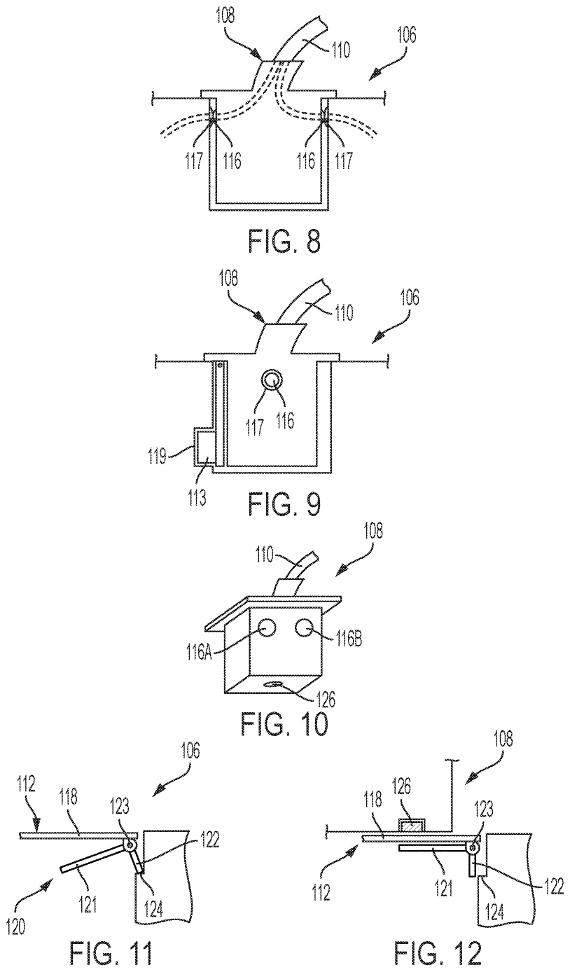

FIG. 5 shows a cross-sectional view of the switch lead socket in an open position from the second direction;

FIG. 8 shows a cross-sectional view of the plug inserted into the switch lead socket from the first direction; excellent FIG. 9 shows a cross-sectional view of the plug inserted into the switch lead socket from the second direction;

FIG. 10 shows a perspective view of the plug of the remote switch lead;

FIG. 11 shows a cross-sectional view of a safety mechanism in a latched position; and

FIG. 12 shows a cross-sectional view of the safety mechanism in an unlatched position.

### DESCRIPTION OF EMBODIMENTS

Remotely switchable power plug apparatus comprises an adapter 101 comprising plug pins 102 and at least one outlet socket 104. The plug pins 102 are configured to plug into a wall socket to provide electrical power from the at least one outlet socket 104.

In embodiment shown, the adapter 101 is a wall mounted adapter having the plug pins 102 on a rear surface 103 thereof and the at least one socket 104 on a front surface 105 thereof. However, it should be appreciated that the adapter 101 can take the form of a power board or the like.

In the embodiment shown, the adapter 101 comprises a pair of sockets 104 although one socket 104 or more than two sockets 104 is also envisaged depending on the application.

In the embodiment shown, the at least one socket 104 and plug pins 102 conform to the Australian standard although could be adapted for other countries too.

The adapter 101 comprises a switch lead socket 106.

The apparatus further comprises a remote switch lead 107 which can be optionally connected to the adapter 101 for remote control functionality.

The remote switch lead 101 comprises a plug 108 which is configured to plug into the switch lead socket 106, a switch 109 and cabling 110 electrically interfacing the plug 108 and the switch 109.

The cabling 110 would have sufficient length depending on the application so as to, for example, be able to reach behind a TV cabinet or the like.

The switch 109 may be moulded into a switch housing 111. In the embodiment shown, the housing 110 comprises a pair of switches 109 for the embodiment wherein the adapter 101 comprises a pair of sockets 104. The switch housing 111 may be adhered to a surface using double sided tape backing or the like.

The plug 108 has plug contacts 116 configured to electrically connect with switch lead socket contacts 117 within an interior 115 of the switch lead socket 106 when the plug 108 is plugged into the switch lead socket 106.

FIGS. 4 and 5 show a cross-sectional view of the switch lead socket 106 from a first direction and FIGS. 6 and 7 show a cross-sectional view of the switch lead socket 106 from an orthogonal direction.

The switch lead socket 106 comprises a swing gate 112 having a conductor 113. The swing gate 112 may be hingedly coupled from a hinge pin 114.

FIG. 4 shows how the gate 112 is biased to a closed position wherein the gate 112 closes the interior 115 of the switch lead socket 106. A coil spring (not shown) may interface around the hinge pin 114 to bias the gate 112 to the closed position,

In the closed position, the conductor 113 electrically connects the interior switch lead socket contacts 117 within the interior 115 of the switch lead socket 106, thereby completing a circuit between the plug pins 102 and the at least one socket 104 of the adapter 101. In other words, when the gate 112 is in the default closed position, the adapter 101 can be used as a normal adapter 101.

The conductor 113 may comprise a strip of copper having formed ends which enhance electrical contact against the switch lead socket contacts 117. These formed ends may be bent in the manner shown to have concavity conforming with convexity of the switch lead socket contacts 117. These ends may flex as the gate 112 opens and closes past the switch lead socket contacts 117.

The gate 112 may comprise a plastic (or similar nonconductive material) cover 118 which electrically insulates the conductor 113 thereunderneath.

FIGS. 5 and 6 show wherein the gate 112 is configured to be deflected by the plug 108 to an open position when the plug 108 is inserted into the switch lead socket 106.

As is shown, the conductor 113 moves away from the switch lead socket contacts 117 and is therefore disconnected from between the switch lead socket contacts 117, thereby breaking the circuit between the plug pins 102 and the at least one socket 104.

As is shown in FIG. 7, the interior 115 may comprise a recess 119 within a side wall of the interior 115 of the switch lead socket 106 to receive the conductor 113 therein to allow the cover 118 to lie flat against the side wall of the switch lead socket 106.

FIG. 7 shows a cross-section of the switch lead socket 106 with the plug 108 inserted therein from a first direction and FIG. 9 shows a cross-section of the switch lead socket 106 from an orthogonal direction.

When the plug 108 is inserted into the interior 115 of the switch lead socket 106, the plug contacts 116 align and electrically connect between the plug socket contacts 116 to create a circuit between the plug pins 102, the at least one outlet socket 104 and the switch 109.

As such, the switch 109 now selectively completes the circuit between the plug pins 102 and at least one outlet socket 104. As such, the switch 109 can be used to control the provision of power by the adapter 101 remotely.

For example, the adapter 101 may be installed behind a TV cabinet or the like and used in the normal manner without the remote switch lead 107 connected thereto. However, to facilitate disconnection of power for power saving purposes, the remote switch lead 107 may be connected to the adapter 101 by plugging the plug 108 thereof into the switch lead socket 106. In this way, the plug 108 interrupts the circuit between the plug pins 102 and the at least one outlet socket 104 created by the conductor of the gate 102 and rather creates a circuit formed by the wiring within the cable 108 between the plug pins 102, the switch 109 and the at least one outlet socket 104. As such, the switch 109 may be placed in a convenient location accessible from behind the TV cabinet to remotely switch the provision of power by the adapter 101.

The plug 108 and socket 106 may have interference fit members therein, such as teeth, ridges or the like which retain the plug 108 within the socket 106 but allow the removal of the plug 108 with sufficient manual traction force.

The switch housing 111 may comprise a power status indicator 125 adjacent the switch 109.

As shown in FIG. 10, the plug 108 may comprise a first pair of plug contacts 116A and a second pair of plug contacts 116B.

The first pair 116A may electrically connect live wiring and the second pair 116B may electrically connect neutral wiring of AC supply wiring of an outlet socket 104.

Alternatively, the first pair 116A may electrically connect live or neutral wiring of a first outlet socket 104A to a first switch 109A whereas the second pair 116B may electrically connect a second outlet socket 104B to a second switch 109B. As such, the pair of switches 109A, 109B may be operated independently for independent control of the outlet socket 104A and 104B.

FIGS. 11 and 12 show a safety mechanism designed to prevent risk of insertion of fingers into the socket 106.

The safety mechanism comprises a concealed latch 120 comprising a magnetic arm 121 close to the cover 118 of the gate 112. In the latched position shown in FIG. 11, the magnetic arm 121 acts on a lever 122 via a hinge 123 which latches against a ledge 124 in a side wall of the outlet socket 106 to prevent the gate 112 from being opened.

FIG. 12 shows wherein a distal face of the plug comprises a permanent magnet 126 installed therein.

When the plug 108 is placed against the cover 112 the gate, the permanent magnet 126 magnetically attracts the magnetic arm 121, thereby causing the latch 122 to move to an unlatched position wherein the lever 122 moves away from the ledge 124 and in latches from the ledge 124 to allow the gate 112 to be pushed open by the plug 108.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. Remotely switchable power plug apparatus comprising:
an adapter comprising:
plug pins;
at least one outlet socket; and
a switch lead socket;
a remote switch lead selectively connectable to the adapter, the remote switch lead comprising:
a plug configured to plug into the switch lead socket, the plug having plug contacts configured to electrically connect with switch lead socket contacts within an interior of the switch lead socket;
a switch;
cabling electrically interfacing the plug and the switch, wherein the switch lead socket comprises:
a swing gate having a conductor, wherein the gate is biased to:
a closed position wherein the gate closes the switch lead socket and the conductor electrically connects the contacts to complete a circuit between the plug pins and the at least one outlet socket, and
wherein the gate is configured to be deflected by the plug to an open position when the plug is inserted into the switch lead socket whereby:
the conductor is disconnected from between the socket contacts;
the plug contacts electrically connect the socket contacts to create a circuit between the plug pins, the at least one outlet socket and the switch and whereby the switch selectively completes the circuit between the plug pins and the at least one outlet socket.

2. The apparatus as claimed in claim 1, wherein the gate comprises an insulative cover covering the conductor there underneath.

3. The apparatus as claimed in claim 1, wherein the conductor comprises a strip of metal and wherein ends thereof are shaped to fit to the switch lead socket contacts to enhance electrical conductivity therebetween.

4. The apparatus as claimed in claim 3, wherein the ends each have concavity to conform to convexity of respective switch lead socket contacts.

5. The apparatus as claimed in claim 1, wherein an interior sidewall of the switch lead socket comprises a recess to accommodate the conductor therein when the gate is open so that the gate can lie flat against the interior sidewall.

6. The apparatus as claimed in claim 1, wherein an interference fit retains the plug within the switch lead socket.

7. The apparatus as claimed in claim 1, wherein the plug comprises first and second pairs of electrical contacts.

8. The apparatus as claimed in claim 7, wherein the first pair electrically connects live wiring and the second pair electrically connects neutral wiring of AC supply wiring.

9. The apparatus as claimed in claim 7, wherein the apparatus comprises first and second switches and wherein the first pair electrically interfaces the first switch and wherein the second pair electrically interfaces the second switch.

10. The apparatus as claimed in claim 1, wherein a coil spring interface around a hinge pin to bias the gate to the closed position,

11. The apparatus as claimed in claim 1, further comprising a safety mechanism for the gate comprising a latch comprising a magnetic arm across the gate acting on a lever latching against a ledge in a side wall of the outlet socket and whereby the plug comprises a magnet installed on a distal face therein which magnetically attracts the magnetic arm, thereby causing the lever to unlatch from the ledge to allow the gate to be opened.

12. The apparatus as claimed in claim 11, wherein the latch is biased to a latched position.

13. A method involving the apparatus as claimed in claim 1, the method comprising:
plugging the adapter into a wall socket without the remote switch lead coupled thereto and drawing power from the at least one outlet socket thereof; and
alternatively plugging the remote switch lead into the switch lead socket to use the switch thereof to selectively control the provision of power from the at least one outlet socket.
